(19) United States
(12) Patent Application Publication
(10) Pub. No.: US 2024/0083059 A1
(43) Pub. Date: Mar. 14, 2024

(54) CUTTING APPARATUS AND CUTTING METHOD FOR EDIBLE PRODUCTS

(71) Applicant: CJ CHEILJEDANG CORPORATION, Gyeonggi-do (KR)

(72) Inventors: Duk Jin CHANG, Seoul (KR); Min Soo LIM, Seoul (KR); Seung Yong KIM, Gyeonggi-do (KR); Yong Ho JEON, Gyeonggi-do (KR); Sang Oh KIM, Gyeonggi-do (KR); Myoung Il KWAK, Gyeonggi-do (KR); Jong Hwa LEE, Gyeonggi-do (KR)

(73) Assignees: CJ CHEILJEDANG CORPORATION, Seoul (KR); CJ SEAFOOD CORPORATION, Gyeonggi-do (KR); GREEN TECHNOLOGY CO., LTD., Gyeonggi-do (KR)

(21) Appl. No.: 18/270,465

(22) PCT Filed: Dec. 28, 2021
(86) PCT No.: PCT/KR2021/020050

§ 371 Date: Jun. 29, 2023

(30) Foreign Application Priority Data
Dec. 29, 2020 (KR) 10-2020-0186726

(51) Int. Cl. B26D 1/40; B26D 7/18

(52) U.S. Cl. CPC B26D 1/40; B26D 7/1863

(57) ABSTRACT

A cutting apparatus according to the present disclosure includes a cutting roller including a cutting body having a cylindrical shape and configured to rotate about an axis defined in a leftward/rightward direction, and cutting blades protruding outward in a radial direction of the cutting body further than a surface of the cutting body to cut an edible food product provided in a forward/rearward direction, and a cutting base part disposed at a position facing the cutting roller based on the edible food product to support the edible food product to be cut by the cutting roller.

### TECHNICAL FIELD

The present disclosure relates to a cutting apparatus for edible food products and a cutting method using the same.

### BACKGROUND ART

Food ingredients need to be delicately treated to make sheet-type edible food products by processing thin food ingredients. In case that the food ingredients are not delicately treated, the food ingredients are torn, wrinkled, or deformed, and subsequent processes may not be normally performed, which may cause the discontinuation of the process and the deterioration in productivity. In case that skilled operators process the food ingredients, it is possible to make edible food products while minimizing a loss of material and production time. However, in case that non-skilled operators perform the work or the work is performed by a machine that is not appropriately designed, the food ingredients cannot be delicately treated, which may cause damage to food ingredient and the deterioration in productivity.

In general, to make edible food products by using thin food ingredients, it is possible to use a method of receiving food ingredients in the form of a stack, which is made by stacking a plurality of food ingredients, separating pieces of food ingredients from the stack, and then performing predetermined processing. In this process, the food ingredients particularly need to be treated delicately.

Meanwhile, the seaweed snack may be processed by being cut into small units having proper sizes so that consumers may easily eat the seaweed snack. However, because of the nature of seaweed, particles, such as debris, are produced during the cutting process and accumulated on or trapped in a cutting apparatus during the repeated process, which may hinder a smooth operation.

### DISCLOSURE

### Technical Problem

The present disclosure has been made in an effort to solve the above-mentioned problems, and an object of the present disclosure is to provide a cutting apparatus and a cutting method using the same, which are capable of smoothly removing particles occurring during a process of cutting an edible food product such as seaweed snack into small pieces, thereby reducing the occurrence of a defect and improving productivity.

### Technical Solution

A cutting apparatus according to an embodiment of the present disclosure includes: a cutting roller including a cutting body having a cylindrical shape and configured to rotate about an axis defined in a leftward/rightward direction, and cutting blades protruding outward in a radial direction of the cutting body further than a surface of the cutting body to cut an edible food product provided in a forward/rearward direction; and a cutting base part disposed at a position facing the cutting roller based on the edible food product to support the edible food product to be cut by the cutting roller.

A cutting method according to another embodiment of the present disclosure includes: receiving an edible food product; cutting the edible food product by rotating a cutting roller including a cutting body having a cylindrical shape and configured to rotate about an axis defined in a leftward/rightward direction, and cutting blades protruding outward in a radial direction of the cutting body further than a surface of the cutting body to cut the edible food product provided in a forward/rearward direction; and spraying gas through a spray hole provided in the cutting body and disposed adjacent to the cutting blade to remove particles at the periphery of the cutting blade.

### Advantageous Effects

Accordingly, it is possible to smoothly remove particles occurring during the process of cutting the edible food product into small pieces, thereby reducing the occurrence of a defect and improving the productivity.

### DESCRIPTION OF DRAWINGS

FIG. 1 is a conceptual view of a system for manufacturing edible food products according to an embodiment of the present disclosure.

FIG. 2 is a perspective view of the system for manufacturing edible food products according to the embodiment of the present disclosure.

FIG. 3 is a right side view of the system for manufacturing edible food products according to the embodiment of the present disclosure.

FIG. 4 is a left side view of the system for manufacturing edible food products according to the embodiment of the present disclosure.

FIG. 5 is a perspective view illustrating that some constituent elements of a cutting apparatus of the system for manufacturing edible food products according to the embodiment of the present disclosure are exposed to the outside.

FIG. 6 is a perspective view illustrating that some constituent elements of the cutting apparatus of the system for manufacturing edible food products according to the embodiment of the present disclosure are exposed to the outside when viewed in another direction.

FIG. 7 is a right side view illustrating that some constituent elements of the cutting apparatus of the system for manufacturing edible food products according to the embodiment of the present disclosure are exposed to the outside.

FIG. 8 is a view illustrating an internal structure of the cutting apparatus of the system for manufacturing edible food products according to the embodiment of the present disclosure.

FIG. 9 is a detailed view illustrating a part of FIG. 8 in detail.

FIG. 10 is a view illustrating an internal structure of a cutting apparatus of a system for manufacturing edible food products according to a modified example of the embodiment of the present disclosure.

FIG. 11 is a detailed view illustrating a part of FIG. 10 in detail.

FIG. 12 is a flowchart of a method of manufacturing edible food products according to the embodiment of the present disclosure.

FIG. 13 is a flowchart of an edible food product cutting method according to the embodiment of the present disclosure.

### MODE FOR DISCLOSURE

Hereinafter, some embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments of the present disclosure, a detailed description of related publicly-known configurations or functions will be omitted when it is determined that the detailed description obscures the understanding of the embodiments of the present disclosure.

In addition, the terms first, second, A, B, (a), and (b) may be used to describe constituent elements of the embodiments of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

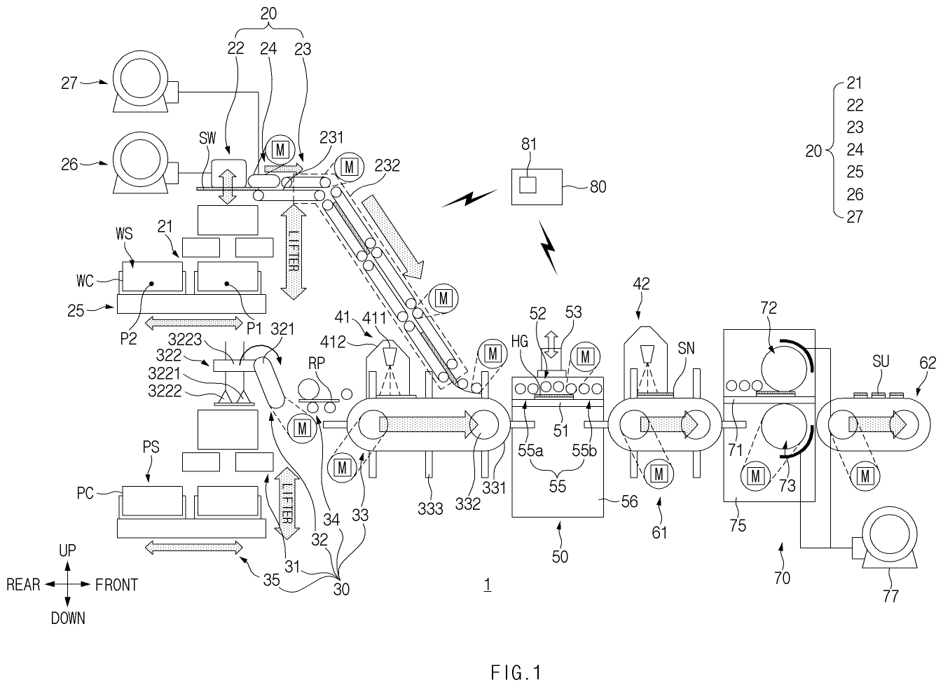

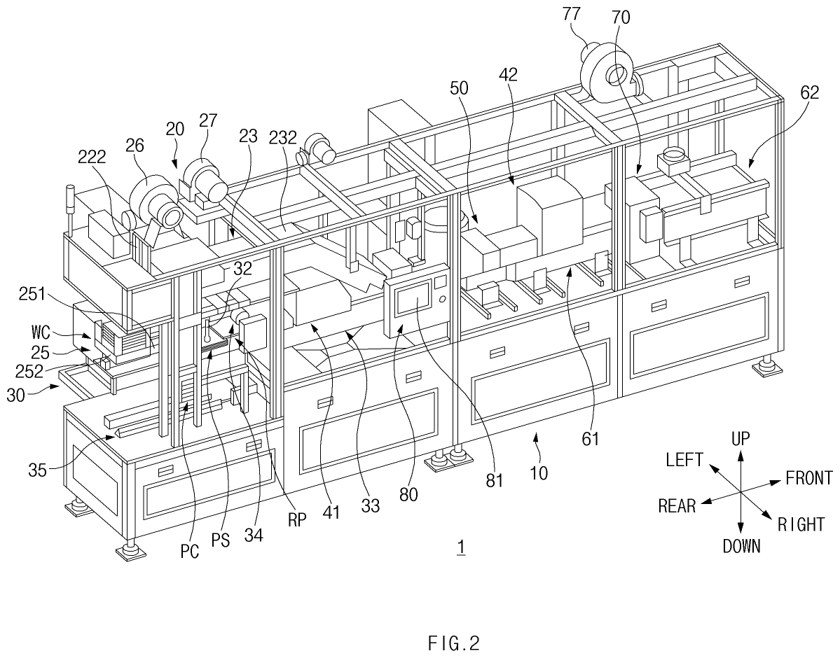

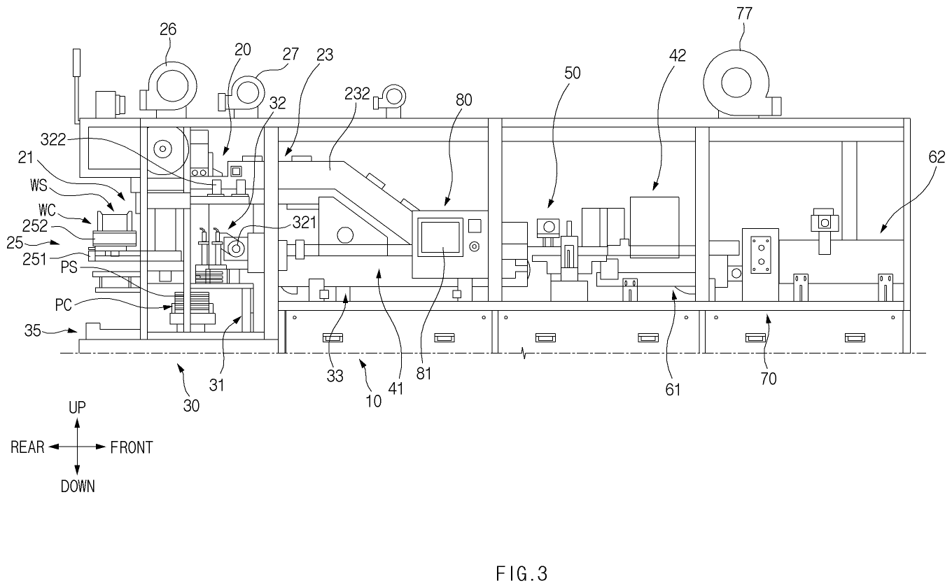

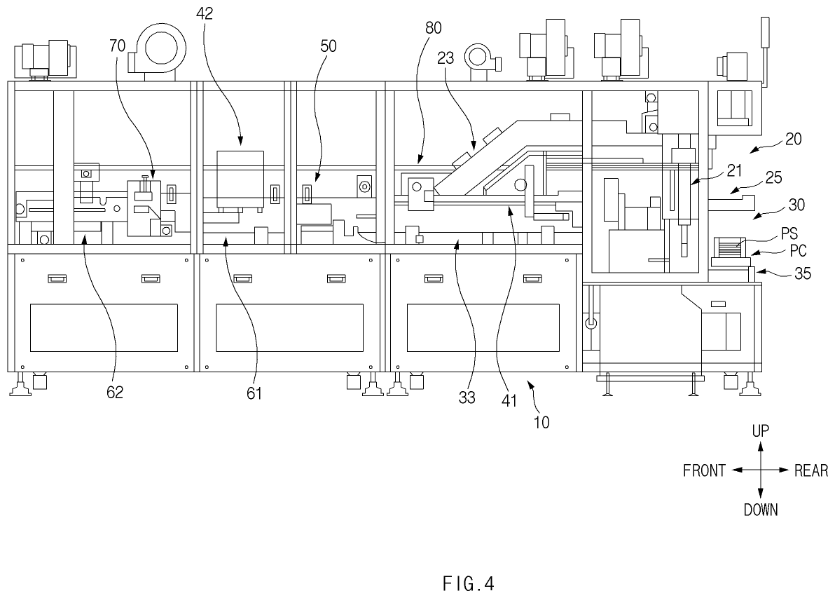

FIG. 1 is a conceptual view of a system 1 for manufacturing edible food products according to an embodiment of the present disclosure. FIG. 2 is a perspective view of the system 1 for manufacturing edible food products according to the embodiment of the present disclosure. FIG. 3 is a right side view of the system 1 for manufacturing edible food products according to the embodiment of the present disclosure. FIG. 4 is a left side view of the system 1 for manufacturing edible food products according to the embodiment of the present disclosure.

Referring to the drawings, the system 1 for manufacturing edible food products according to the embodiment of the present disclosure includes a first food ingredient supply apparatus 20, a second food ingredient supply apparatus 30, and a pressing device 50. The system 1 for manufacturing edible food products according to the embodiment of the present disclosure may include a system frame 10, a joining agent spray device 41, an auxiliary joining agent spray device 42, an intermediate conveyor 61, an unloading conveyor 62, a cutting apparatus 70, and a processor 80.

In the present specification, a forward/rearward direction, a leftward/rightward direction, and an upward/downward direction are defined for convenience of description and may be orthogonal to one another. However, these directions are defined relative to the direction in which the system 1 for manufacturing edible food products is arranged. The upward/downward direction may not necessarily mean a vertical direction.

The edible food products produced by the system 1 for manufacturing edible food products according to the embodiment of the present disclosure may be seaweed snack SN. The food ingredients used to produce the edible food products may include a first food ingredient and a second food ingredient. The first food ingredient may be seaweed SW, and the second food ingredient may be rice paper RP. A unit product produced by cutting the edible food products may be unit snack SU. Therefore, hereinafter, the configuration and operation of the system 1 for manufacturing edible food products will be described by using the seaweed snack SN instead of the edible food product, a single sheet of seaweed SW instead of a single sheet of a first food ingredient, a seaweed stack WS instead of a first food ingredient stack, a seaweed cassette WC instead of a first food ingredient cassette, a single sheet of rice paper RP instead of a single sheet of a second food ingredient, a paper stack PS instead of a second food ingredient stack, a paper cassette PC instead of a second food ingredient cassette, and the unit snack SU instead of a unit product. However, the edible food product, the first food ingredient, and the second food ingredient are not limited thereto.

The first food ingredient supply apparatus 20 and the second food ingredient supply apparatus 30 may be disposed at a rear end of the system 1 for manufacturing edible food products. The first food ingredient supply apparatus 20 and the second food ingredient supply apparatus 30 may respectively supply the seaweed and the rice paper forward, thereby making a semi-finished product HG in which the seaweed is seated on the rice paper. The semi-finished product HG may be manufactured as the seaweed snack SN by being pressed by the pressing device 50 disposed forward of the first food ingredient supply apparatus 20 and the second food ingredient supply apparatus 30. The first food ingredient supply apparatus 20 may be disposed above the second food ingredient supply apparatus 30 so that the provided seaweed may be easily seated on the rice paper.

The system 1 for manufacturing edible food products according to the embodiment of the present disclosure may include the system frame 10. The system frame 10 is a constituent element serving as a framework provided to fix relative positions of the constituent elements included in the system 1 for manufacturing edible food products. The system frame 10 may be configured by coupling beams extending in the leftward/rightward direction, the forward/rearward direction, and the upward/downward direction.

First Food Ingredient Supply Apparatus 20

The first food ingredient supply apparatus 20 is provided to separate the single sheet of seaweed SW from the seaweed stack WS including a plurality of stacked seaweed sheets and supply the single sheet of seaweed SW. The seaweed stack WS may be seated on the seaweed cassette WC and supplied.

The first food ingredient supply apparatus 20 may include a first food ingredient cassette movement part 25. The first food ingredient cassette movement part 25 is provided to selectively position the seaweed cassette WC at a first lifting position and a second lifting position positioned rearward of the first lifting position. The first food ingredient cassette movement part 25 may include a first food ingredient cassette rail 251 extending in the forward/rearward direction, and a first food ingredient cassette seating part 252 coupled to the first food ingredient cassette rail 251 so as to be slidable in the forward/rearward direction. The seaweed cassette WC may be seated on the first food ingredient cassette seating part 252 and provided along the first food ingredient cassette rail 251.

The first food ingredient supply apparatus 20 may include the first food ingredient lifting part 21. The first food ingredient lifting part 21 is provided to separate and move the seaweed stack WS upward from the seaweed cassette WC on which the seaweed stack WS including the plurality of stacked seaweed sheets is seated.

The first food ingredient supply apparatus 20 may include the first food ingredient separation part 22. The first food ingredient separation part 22 is provided to grip and move the single sheet of seaweed SW from the seaweed stack WS. The first food ingredient separation part 22 may move upward or downward. The first food ingredient separation part 22 may suck the single sheet of seaweed SW at the upper end of the seaweed stack WS and move the single sheet of seaweed SW upward.

The first food ingredient lifting blower 26 may continuously maintain an operating state in the situation in which the first food ingredient separation part 22 repeatedly provides or cuts off negative pressure while moving upward or downward.

The first food ingredient supply apparatus 20 may include the horizontal movement part 24. The horizontal movement part 24 is provided to transfer forward the single sheet of seaweed SW moved upward by the suction block 221 of the first food ingredient separation part 22. The horizontal movement part 24 may be a suction conveyor. The horizontal movement part 24 is disposed so that a lower surface thereof comes into contact with the upper surface of the single sheet of seaweed SW moved upward by the first food ingredient separation part 22. The horizontal movement part 24 is provided to transfer forward the single sheet of seaweed SW that is in contact with the horizontal movement part 24.

The first food ingredient supply apparatus 20 may include a first food ingredient transfer part 23. The first food ingredient transfer part 23 may be provided to transfer the single sheet of seaweed SW, which has been separated by the first food ingredient separation part 22 and delivered forward by the horizontal movement part 24, to the pressing device 50. The first food ingredient transfer part 23 may include a plurality of first food ingredient transfer conveyors 231. The first food ingredient transfer part 23 may include a first food ingredient transfer housing 232 configured to surround an interior thereof so that the interior is spatially separated from the outside.

Second Food Ingredient Supply Apparatus 30

The second food ingredient supply apparatus 30 is provided separate the single sheet of rice paper RP from the paper stack PS including a plurality of stacked rice paper sheets and supply the single sheet of rice paper RP. The paper stack PS may be seated on the paper cassette PC and supplied.

The second food ingredient supply apparatus 30 may include a second food ingredient cassette movement part 35 and a second food ingredient lifting part 31. Because the description of the second food ingredient cassette movement part 35 and the second food ingredient lifting part 31 is identical to the description of the first food ingredient cassette movement part 25 and the first food ingredient lifting part 21, except that the seaweed is changed to the rice paper, the description of the second food ingredient cassette movement part 35 and the second food ingredient lifting part 31 is replaced with the description of the first food ingredient cassette movement part 25 and the first food ingredient lifting part 21.

The second food ingredient supply apparatus 30 may include a second food ingredient separation part 32. The second food ingredient separation part 32 is provided to grip and move forward the single sheet of rice paper RP from the paper stack PS. The second food ingredient separation part 32 may include a second food ingredient holding member 322 configured to grip the single sheet of rice paper RP, and a swing arm 321 configured to move the single sheet of rice paper RP sucked by the second food ingredient holding member 322.

The second food ingredient holding member 322 is provided to grip, by suction, a single sheet of rice paper RP positioned at an uppermost side among the plurality of rice paper sheets included in the paper stack PS.

The second food ingredient holding member 322 may include a plurality of second food ingredient suction heads 3221 and 3222. The second food ingredient suction heads 3221 and 3222 may be slidably and fixedly coupled to a second food ingredient gripping frame 3223 so that intervals between the second food ingredient suction heads 3221 and 3222 may be adjusted.

The second food ingredient supply apparatus 30 may include the second food ingredient transfer part 33. The second food ingredient transfer part 33 is provided to transfer the single sheet of rice paper RP, which has been delivered by the second food ingredient separation part 32, to the pressing device 50.

The second food ingredient transfer part 33 may include second food ingredient holding rollers 34. The second food ingredient holding rollers 34 are rollers that may be stopped or rotated to deliver the rice paper to a second food ingredient conveyor, which will be described below, at an appropriate time without immediately delivering and transferring the single sheet of rice paper RP to the second food ingredient conveyor when the single sheet of rice paper RP is delivered by the second food ingredient separation part 32.

The second food ingredient conveyor may include a second food ingredient belt 331, and a second food ingredient roller 332 configured to rotate the second food ingredient belt 331. The second food ingredient transfer part 33 may include second food ingredient position fixing bars 333. A plurality of second food ingredient position fixing bars 333 may be disposed on the second food ingredient conveyor and spaced apart from one another in the forward/rearward direction. The plurality of second food ingredient position fixing bars 333 may protrude outward in the forward/rearward direction or the upward/downward direction from the second food ingredient conveyor.

Joining Agent Spray Device 41

The system 1 for manufacturing edible food products according to the embodiment of the present disclosure may include the joining agent spray device 41. The joining agent spray device 41 may include a spray nozzle 411. The spray nozzle 411 may be connected to a joining agent supply part and spray the joining agent onto the upper surface of the rice paper transferred by the second food ingredient conveyor.

The joining agent spray device 41 may include a spray cover 412. The spray cover 412 may allow the joining agent sprayed from the spray nozzle 411 to be sprayed onto the rice paper only in a region in the spray cover 412 without scattering to the outside.

Pressing Device 50

The pressing device 50 is provided to manufacture the seaweed snack SN by pressing the semi-finished product HG made by seating the supplied single sheet of seaweed SW on the supplied single sheet of rice paper RP. The pressing device 50 may press the seaweed and the rice paper against each other.

The pressing device 50 may include a pressing base part 51. The pressing base part 51 is provided such that the semi-finished product HG moves forward along an upper surface of the pressing base part 51. The pressing base part 51 serves to support the semi-finished product HG when a pressing roller part 52 to be described below presses the semi-finished product HG.

The pressing device 50 may include a pressing lifting part 53. The pressing lifting part 53 may be coupled to a pressing frame 56 coupled to the pressing base part 51 may move upward or downward.

The pressing device 50 may include the pressing roller part 52. The pressing roller part 52 is coupled to the pressing lifting part 53 and configured to be rotatable about the axis defined in the leftward/rightward direction so as to press downward the semi-finished product HG that passes a lower side of the pressing roller part 52.

The pressing device 50 may include guide roller parts 55. The guide roller part 55 is rotatably disposed at a position spaced apart upward from the pressing base part 51 so as to guide the semi-finished product HG between the pressing roller part 52 and the pressing base part 51. The guide roller part 55 may come into contact with the upper surface of the semi-finished product HG or the seaweed snack SN and transfer the semi-finished product HG or the seaweed snack SN forward.

In the embodiment of the present disclosure, the guide roller part 55 is illustrated as including a front guide roller part 55b positioned forward of the pressing roller part 52, and a rear guide roller part 55a positioned rearward of the pressing roller part 52, but the arrangement is not limited thereto.

Intermediate Conveyor 61 and Auxiliary Joining Agent Spray Device 42

The system 1 for manufacturing edible food products according to the embodiment of the present disclosure may include the intermediate conveyor 61. The intermediate conveyor 61 may be disposed between the pressing device 50 and the cutting apparatus 70 and configured to deliver the seaweed snack SN. The intermediate conveyor 61 may be provided such that the seaweed snack SN unloaded from the pressing device 50 is seated on an upper surface of the intermediate conveyor 61. The intermediate conveyor 61 may rotate to transfer forward the seaweed snack SN seated on the upper surface of the intermediate conveyor 61. The intermediate conveyor 61 may rotate by receiving driving power so that the above-mentioned operation is possible.

The seaweed snack SN, which is unloaded from the pressing device 50, may be dried for a predetermined time for which the seaweed snack SN is transferred to the cutting apparatus 70 by the intermediate conveyor 61, such that the seaweed snack SN may become easy to cut by the cutting apparatus 70.

The system 1 for manufacturing edible food products according to the embodiment of the present disclosure may include the auxiliary joining agent spray device 42. The auxiliary joining agent spray device 42 is provided adjacent to the intermediate conveyor 61 to spray an auxiliary joining agent onto the upper surface of the seaweed snack SN transferred by the intermediate conveyor 61. The auxiliary joining agent spray device 42 may be penetrated by the intermediate conveyor 61 or disposed to cover the intermediate conveyor 61. Because the description of the auxiliary joining agent spray device 42 is identical to the description of the joining agent spray device 41, except that the rice paper is changed to the seaweed snack SN and the joining agent is changed to the auxiliary joining agent, the description of the auxiliary joining agent spray device 42 is replaced with the joining agent spray device 41.

Cutting Apparatus 70

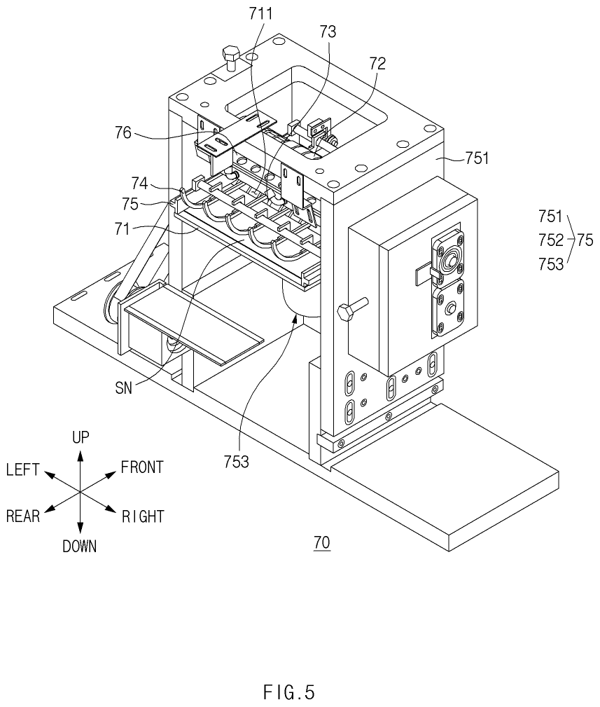

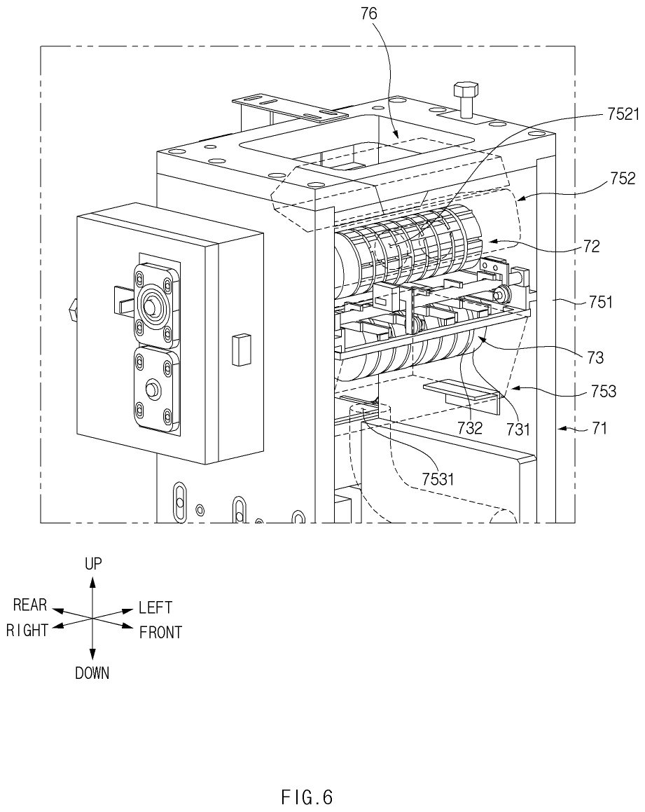

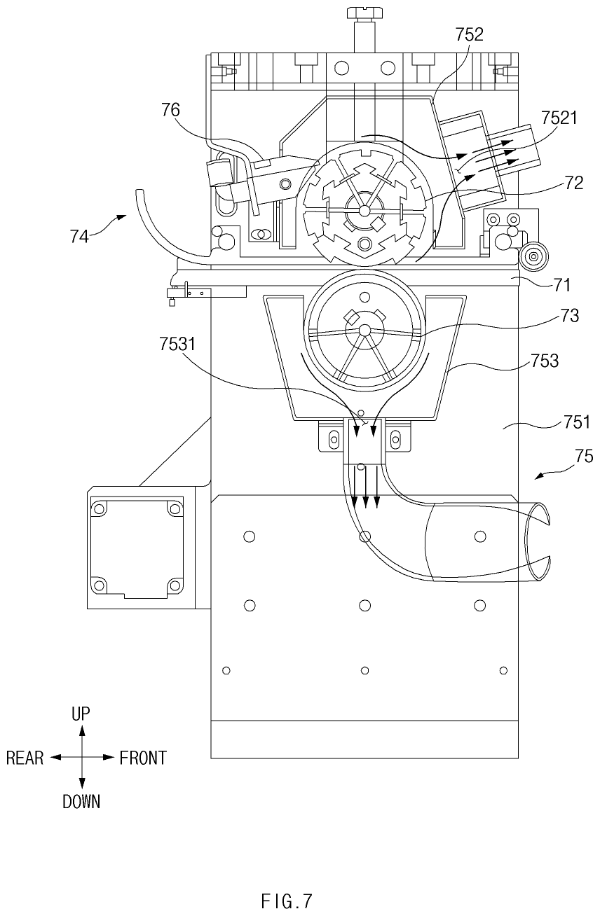

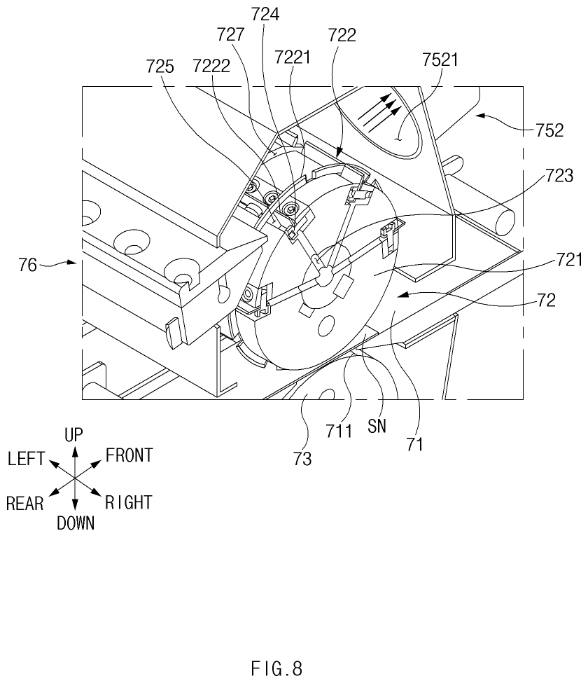

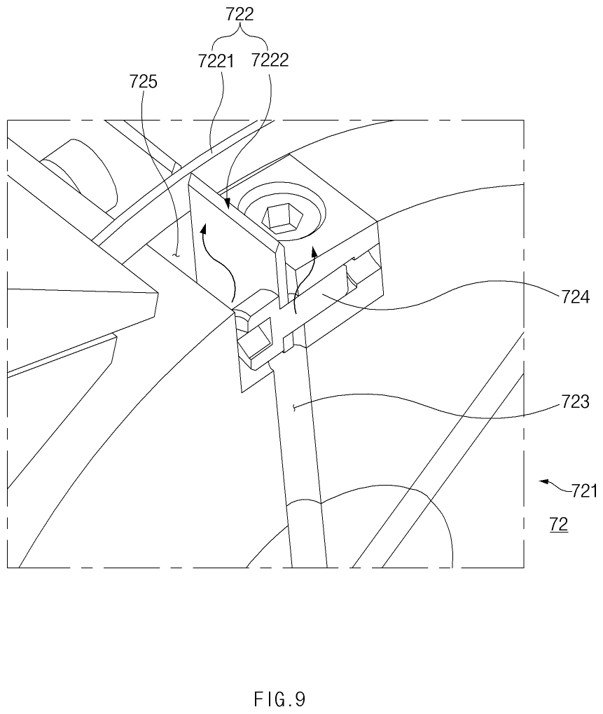

FIG. 5 is a perspective view illustrating that some constituent elements of the cutting apparatus 70 of the system 1 for manufacturing edible food products according to the embodiment of the present disclosure are exposed to the outside. FIG. 6 is a perspective view illustrating that some constituent elements of the cutting apparatus 70 of the system 1 for manufacturing edible food products according to the embodiment of the present disclosure are exposed to the outside when viewed in another direction. FIG. 7 is a right side view illustrating that some constituent elements of the cutting apparatus 70 of the system 1 for manufacturing edible food products according to the embodiment of the present disclosure are exposed to the outside. FIG. 8 is a view illustrating an internal structure of the cutting apparatus 70 of the system 1 for manufacturing edible food products according to the embodiment of the present disclosure. FIG. 9 is a detailed view illustrating a part of FIG. 8 in detail.

The system 1 for manufacturing edible food products according to the embodiment of the present disclosure may include the cutting apparatus 70. The cutting apparatus 70 is provided to cut the seaweed snack SN, which is unloaded from the pressing device 50, into a plurality of small pieces of unit snack SU. To receive the seaweed snack SN unloaded forward from the pressing device 50, the cutting apparatus 70 may be disposed forward of the pressing device 50 and disposed forward of the intermediate conveyor 61.

The cutting apparatus 70 may include a cutting roller 72 and a cutting base part 71. The cutting roller 72 may be disposed above the cutting base part 71. The seaweed snack SN may be transferred forward along an upper surface of the cutting base part 71 and cut by the rotating cutting roller 72 into small pieces of unit snack SU, and then the unit snack SU may be unloaded forward.

The cutting base part 71 is disposed at a position facing the cutting roller 72 based on the seaweed snack SN in order to support the seaweed snack SN to be cut by the cutting roller 72. In the embodiment of the present disclosure, the cutting base part 71 may be disposed at a lower side based on the seaweed snack SN, and the cutting roller 72 may be disposed at an upper side based on the seaweed snack SN. Therefore, the seaweed snack SN may be transferred forward along the upper surface of the cutting base part 71. An auxiliary opening 711 may be formed in the cutting base part 71. The auxiliary opening 711 may extend in the leftward/rightward direction and be opened in the upward/downward direction.

The cutting roller 72 may include a cutting body 721 and cutting blades 722. The cutting body 721 may have a cylindrical shape and be coupled to a cutting frame 75, which will be described below, so as to be rotatable about the axis defined in the leftward/rightward direction. The cutting body 721 may be disposed to be spaced apart upward from the cutting base part 71. The cutting blade 722 protrudes outward in a radial direction of the cutting body 721 further than a surface of the cutting body 721 in order to cut the seaweed snack SN provided in the forward/rearward direction. The cutting blade 722 is coupled to the cutting body 721, and a distal end of the cutting blade 722 protrudes outward further than an outer surface of the cutting body 721, such that the cutting blade 722 may come into contact with the seaweed snack SN and cut the seaweed snack SN when the cutting body 721 rotates. The cutting blade 722 may be inserted into the auxiliary opening 711 at the time of cutting the seaweed snack SN.

The cutting blades 722 may include a forward/rearward cutting blade 7221 and a leftward/rightward cutting blade 7222. The forward/rearward cutting blade 7221 is the cutting blade 722 extending in the circumferential direction of the cutting body 721. The forward/rearward cutting blade 7221 may come into contact with the seaweed snack SN and form a cut surface on the seaweed snack SN, the cut surface extending in the forward/rearward direction. Therefore, the forward/rearward cutting blade 7221 may cut the seaweed snack SN in the leftward/rightward direction. The leftward/rightward cutting blade 7222 is the cutting blade 722 extending in the leftward/rightward direction. The leftward/rightward cutting blade 7222 may come into contact with the seaweed snack SN and form a cut surface on the seaweed snack SN, the cut surface extending in the leftward/rightward direction. Therefore, the leftward/rightward cutting blade 7222 may cut the seaweed snack SN in the forward/rearward direction. The cutting blade 722 may be formed over the entire circumference of the cutting body 721 or formed on only a part of the circumference of the cutting body 721 when the cutting body 721 is viewed in the leftward/rightward direction.

A line made by extending the forward/rearward cutting blade 7221 and a line made by extending the leftward/rightward cutting blade 7222 may intersect each other. Therefore, the seaweed snack SN may be cut in the leftward/rightward direction and the forward/rearward direction by the cutting blade 722 and divided into a plurality of pieces of unit snack SU. In the embodiment, the leftward/rightward cutting blade 7222 and the forward/rearward cutting blade 7221 may intersect each other. The forward/rearward cutting blades 7221 may be continuously connected at the intersection point between the forward/rearward cutting blade 7221 and the leftward/rightward cutting blade 7222. However, the leftward/rightward cutting blade 7222 may be segmentalized by the forward/rearward cutting blade 7221.

The cutting roller 72 may further include cutting grooves 725 recessed inward from a surface of the cutting body 721 in the radial direction of the cutting body 721. A base portion of the cutting blade 722 is inserted into the cutting groove 725. A cutting edge of the cutting blade 722, which performs the cutting, may protrude outward in the radial direction of the cutting body 721 further than the surface of the cutting body.

The base portion of the cutting blade 722 may be coupled to the cutting body 721 in the cutting groove 725. The cutting roller 72 may include blade coupling bolts 724 configured to couple the cutting blades 722 to the cutting body 721 in a direction orthogonal to the direction in which the cutting blade 722 extends. The direction in which the blade coupling bolt 724 couples the cutting blade 722 to the coupling body may be a tangential direction of the cutting body 721 that may be defined at the position at which the blade coupling bolt 724 is disposed when the cutting body 721 is viewed in the leftward/rightward direction. To ensure a space in which the bolt may be coupled, the cutting groove 725 may be formed to have a width larger than a thickness of the cutting blade 722.

The cutting body 721 may have guide grooves 727. The guide groove 727 is formed to be recessed inward from the surface of the cutting body 721 in the radial direction of the cutting body 721. The cutting grooves 725 and the guide grooves 727 may be alternately disposed in the leftward/rightward direction. A cutting guide rail 74 to be described below may be inserted into the guide groove 727. Because the guide groove 727 is present, the lower side of the seaweed snack SN may be supported by the cutting guide rail 74, and the forward movement of the seaweed snack SN or the operation of cutting the seaweed snack SN by the cutting blade 722 may not be hindered by the cutting roller 72.

The cutting roller 72 may include a spray hole 723. The spray hole 723 may be provided as a plurality of spray holes 723. The spray hole 723 is a hole formed through the cutting body 721 outward in the radial direction from the center of the cutting body 721 in order to spray gas outward in the radial direction of the cutting body 721 at the periphery of the cutting blade 722. Because the spray hole 723 is present, the spray hole 723 may blow particles, such as seaweed debris, which may remain on the cutting blade 722 at the time of cutting the seaweed snack SN, to separate the particles from the cutting blade 722, thereby allowing the cutting roller 72 to consistently and easily perform the cutting function.

The spray hole 723 may allow a cutting center hole, which is formed in the leftward/rightward direction at an innermost side of the cutting body 721, to communicate with the outside. The cutting center hole may be connected to a cutting blower configured to pump compressed gas, such that the cutting center hole may receive the compressed gas and discharge the compressed gas through the spray hole 723. The compressed gas may be compressed air.

The spray hole 723 may be formed in a bottom surface of the cutting groove 725 disposed inward of the blade coupling bolt 724 based on the radial direction of the cutting body 721. Therefore, because the gas discharged through the spray holes 723 flows at the periphery of the blade coupling bolts 724 and the cutting blades 722, the gas may flow while rotating about axes of the blade coupling bolts 724. Therefore, the gas may easily separate particles, which are present at the periphery of the blade coupling bolts 724 and the cutting blades 722, from the blade coupling bolts 724 and the cutting blades 722.

The cutting apparatus 70 may include the cutting frame 75. The cutting frame 75 may be a constituent element such as a framework to which the constituent elements of the cutting apparatus 70 are coupled so that relative positions between the constituent elements are fixed. The cutting base part 71 may be coupled to the cutting frame 75, and the cutting roller 72 may be rotatably coupled to the cutting frame 75.

The cutting frame 75 may include a main cutting frame 751 to which the cutting base part 71 is coupled, and a first cutting cover 752 coupled to the main cutting frame 751. The first cutting cover 752 covers the cutting roller 72. The first cutting cover 752 covers the cutting roller 72 so that the cutting roller 72 is positioned in a space formed between the first cutting cover 752 and the cutting base part 71. Therefore, the first cutting cover 752 may be disposed above the cutting base part 71.

The cutting frame 75 may include a second cutting cover 753 coupled to the main cutting frame 751. The second cutting cover 753 may cover an auxiliary roller 73 so that the auxiliary roller 73 is positioned in a space formed between the second cutting cover 753 and the cutting base part 71. Therefore, the second cutting cover 753 may be disposed below the cutting base part 71.

The cutting apparatus 70 may include a cutting suction part. A first cutting suction part may be connected to a first cover inlet port 7521 formed in the first cutting cover 752. The first cutting suction part provides negative pressure to the first cover inlet port 7521, such that debris exiting at the periphery of the cutting roller 72 positioned in the first cutting cover 752 may be sucked through the first cover inlet port 7521. The first cover inlet port 7521 may be disposed forward of the cutting body 721 and opened in a direction inclined upward in the forward direction.

The cutting apparatus 70 may include a second cutting suction part. The second cutting suction part may be connected to a second cover inlet port 7531 formed in the second cutting cover 753. The second cutting suction part provides negative pressure to the second cover inlet port 7531, such that debris exiting at the periphery of the auxiliary roller 73 positioned in the second cutting cover 753 may be sucked into the second cover inlet port 7531. The second cover inlet port 7531 may be disposed below an auxiliary body 731 and opened downward. The first cutting suction part and the second cutting suction part may be a single common cutting suction blower 77.

The cutting apparatus 70 may include the auxiliary roller 73. The auxiliary roller 73 is disposed at a position facing the cutting roller 72 based on the seaweed snack SN to move the seaweed snack SN forward and support the seaweed snack SN when the cutting roller 72 cuts the seaweed snack SN. Like the cutting roller 72, the auxiliary roller 73 may be coupled to the cutting frame 75 so as to be rotatable about the axis defined in the leftward/rightward direction. The cutting roller 72 and the auxiliary roller 73 may be rotatably coupled to the main cutting frame 751. The cutting roller 72 and the auxiliary roller 73 may receive driving power from the same drive part. The cutting roller 72 and the auxiliary roller 73 may be gear-coupled to each other and operate in conjunction with each other. The auxiliary roller 73 and the cutting roller 72 may be disposed at sides opposite to each other based on the auxiliary opening 711.

The auxiliary roller 73 may include the auxiliary body 731 having a cylindrical shape and rotatably coupled to the cutting frame 75, and an auxiliary groove 732. An outer surface of the auxiliary body 731 may come into contact with the lower surface of the seaweed snack SN and support the seaweed snack SN upward while pushing the seaweed snack SN forward. The auxiliary groove 732 is a groove recessed inward from the auxiliary body 731 in the radial direction of the auxiliary body 731 so that the cutting blade 722, which protrudes outward in the radial direction of the cutting body 721 further than the surface of the cutting body 721, may be inserted into the auxiliary groove 732. The cutting blade 722 may be inserted into the auxiliary groove 732 when the cutting process is performed. Because the cutting blade 722 is inserted into the auxiliary groove 732, the auxiliary roller 73 may support the seaweed snack SN without colliding with the cutting blade 722.

The cutting apparatus 70 may include an air knife 76. The air knife 76 may be disposed to face the cutting blade 722 to spray air to the cutting blade 722. The air knife 76 may have a slit extending in the leftward/rightward direction and spray compressed air through the slit. The air knife 76 may be disposed to penetrate the first cutting cover 752 disposed rearward of the cutting roller 72. A direction in which the air knife sprays air may not be parallel to a direction of a tangential line formed at a point at which a straight line extending in the direction in which the air knife sprays air reaches the cutting body 721.

The cutting apparatus 70 may include the cutting guide rail 74. The cutting guide rail 74 is provided to prevent the seaweed snack SN from being wound around the cutting roller 72. The cutting guide rail 74 may extend in the forward/rearward direction. The cutting guide rail 74 may be provided as a plurality of cutting guide rails 74. The cutting guide rail 74 may be disposed below the surface of the cutting body 721. However, a lower end of the cutting guide rail 74 may be positioned above a lower end of the cutting blade 722. Therefore, an upward motion of the unit snack SU, which is cut by the cutting roller 72 and unloaded forward, is restricted by the cutting guide rail 74, such that the unit snack SU may not be wound around the cutting roller 72 even though the cutting roller 72 rotates. In addition, because the cutting guide rail 74 is positioned above the cutting blade 722, the cutting guide rail 74 may not hinder the cutting operation of the cutting blade 722.

To enable a height relationship between the cutting guide rail 74 and the cutting blade 722, the cutting guide rail 74 may come into contact with the cutting body 721 or be inserted into the guide groove 727 formed in the cutting body 721.

The cutting guide rail 74 may be provided as a plurality of cutting guide rails 74. The plurality of cutting guide rails 74 may be disposed to be spaced apart from one another in the leftward/rightward direction. A distance at which the cutting guide rails 74 are spaced apart from each other in the leftward/rightward direction may be a distance corresponding to a distance at which the guide grooves 727 are spaced apart from each other in the leftward/rightward direction.

Front and rear ends of the cutting guide rail 74 may have shapes inclined upward with respect to the outside based on the forward/rearward direction. When the seaweed snack SN enters the lower side of the cutting roller 72, the seaweed snack SN may be easily guided to the lower side of the cutting guide rail 74. When the unit snack SU exits the cutting apparatus 70, the unit snack SU may slowly separate in a direction from the upper surface of the unit snack SU.

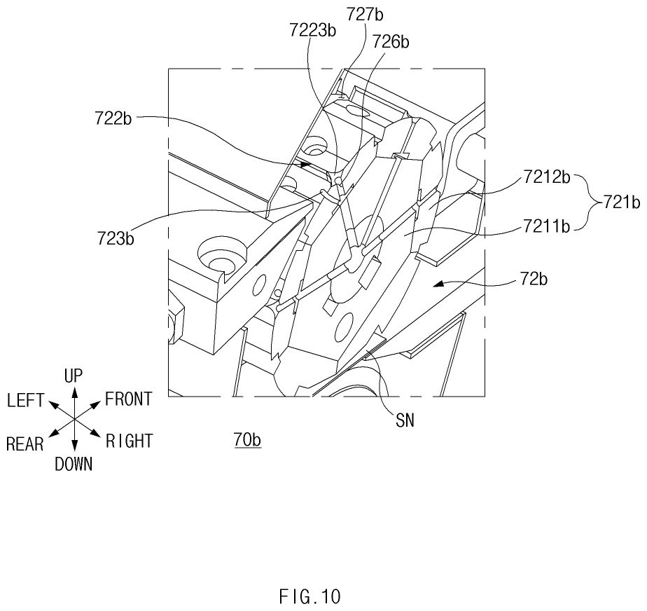

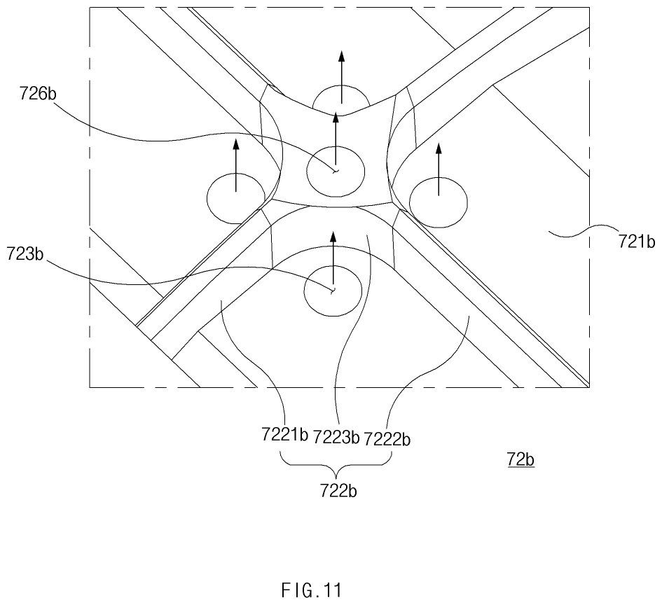

FIG. 10 is a view illustrating an internal structure of a cutting apparatus 70b of a system for manufacturing edible food products according to a modified example of the embodiment of the present disclosure. FIG. 11 is a detailed view illustrating a part of FIG. 10 in detail.

The cutting apparatus 70b according to the modified example of the embodiment of the present disclosure is different in shape from the cutting blade 722b. Therefore, only the difference will be further described. Because the description of the remaining parts of the cutting apparatus 70b is identical to the description of the cutting apparatus 70 according to the embodiment, the description of the remaining parts of the cutting apparatus 70b is replaced with the description of the cutting apparatus 70 according to the embodiment.

Cutting blades 722b according to the modified example of the embodiment of the present disclosure may include leftward/rightward cutting blades 7222b, forward/rearward cutting blades 7221b, and connection cutting blades 7223b. The connection cutting blade 7223b may be disposed at a position at which the forward/rearward cutting blade 7221b and the leftward/rightward cutting blade 7222b meet together. The connection cutting blade 7223b connects the forward/rearward cutting blade 7221b and the leftward/rightward cutting blade 7222b. Therefore, the forward/rearward cutting blade 7221b and the leftward/rightward cutting blade 7222b do not meet together but may be connected to each other by means of the connection cutting blade 7223b.

The connection cutting blade 7223b may have a curved surface that connects the forward/rearward cutting blade 7221b and the leftward/rightward cutting blade 7222b. That is, the connection cutting blade 7223b may serve to produce the unit snack SU having a rounded corner by chamfering the corner of the unit snack SU that may be cut into a rectangular shape by the leftward/rightward cutting blade 7222b and the forward/rearward cutting blade 7221b. The connection cutting blade 7223b may have a shape such as a rectangular shape having an edge concavely recessed inward when viewed in a radial direction of a cutting body 721b. A cutting edge of the connection cutting blade 7223b may have a shape concavely recessed inward in the radial direction of the cutting body 721b between the vertices.

A cutting roller 72b according to the modified example of the embodiment of the present disclosure may not include the cutting groove 725. However, although not illustrated, an embodiment including both the cutting groove 725 and the connection cutting blade 7223b may be carried out. In addition, as illustrated, the cutting roller 72b may include guide grooves 727b. Because the cutting roller 72b may not include the cutting groove 725, the plurality of guide grooves 727b may be disposed in the leftward/rightward direction at positions at which the cutting blade 722b is not formed.

Spray holes 723b according to the modified example of the embodiment of the present disclosure may be disposed at the periphery of the connection cutting blades 7223b. In the drawings, a total of four spray holes 723b are illustrated as being disposed, but the number of spray holes 723b is not limited thereto.

The cutting roller 72b according to the modified example of the embodiment of the present disclosure may include connection spray holes 726b. The connection spray hole 726b is a hole formed through the connection cutting blade 7223b and the cutting body 721b outward in the radial direction of the cutting body 721b in order to spray gas outward in the radial direction of the cutting body 721b. Remnants and debris of the seaweed snack SN, which may be produced when the connection cutting blade 7223b cuts the seaweed snack SN, may be removed by the spray holes 723b and the connection spray holes 726b.

The connection spray hole 726b may be connected to the spray hole 723b in the cutting body 721b. The spray hole 723b and the connection spray hole 726b may be formed as the same hole formed outward in the radial direction from the center of the cutting body 721b and separated from each other before the spray hole 723b and the connection spray hole 726b reach the surface of the cutting body 721b.

The cutting body 721b of the cutting roller 72b according to the modified example of the embodiment of the present disclosure may include an outer cutting body 7212b and an inner cutting body 7211b. The inner cutting body 7211b may be provided at a central portion of the cutting body 721b in the radial direction. The outer cutting body 7212b may be coupled to an outer surface of the inner cutting body 7211b and define the cutting body 721 having a cylindrical shape. The outer cutting body 7212b may be coupled to the outer surface of the inner cutting body 7211b in a dovetail manner. The feature in which the cutting body 721b is divided into the inner and outer structures may also be applied to the cutting body 721 according to the embodiment of the present disclosure.

Unloading Conveyor 62

The system 1 for manufacturing edible food products according to the embodiment of the present disclosure may include the unloading conveyor 62. The unloading conveyor 62 may be disposed at the front end of the cutting apparatus 70 and configured to deliver the unit snack SU to subsequent processes. The subsequent processes may include a packaging process, a post-treatment process, and the like. The unloading conveyor 62 may be provided so that the unit snack SU unloaded from the cutting apparatus 70 is seated on an upper surface of the unloading conveyor 62. The unloading conveyor 62 may transfer forward the unit snack SU seated on the upper surface while rotating. The unloading conveyor 62 may rotate by receiving driving power so that the above-mentioned operation is possible.

Processor 80

The processor 80 is provided to control the system 1 for manufacturing edible food products. The processor 80 is a constituent element including an element capable of performing a logical operation that executes a control instruction. The processor 80 may include a central processing unit (CPU) or the like. The processor 80 may be connected to various types of constituent elements and perform control by transmitting signals according to the control instruction to the respective constituent elements. The processor 80 may be connected to various types of sensors or acquisition parts and receive the acquired information in the form of signals. Therefore, in the embodiment of the present disclosure, the processor 80 may be electrically connected to various types of constituent elements including the system for manufacturing the seaweed snack SN. Because the processor 80 may be electrically connected to the respective constituent elements, the processor 80 may be connected to the constituent element by means of a conductive wire. Alternatively, the processor 80 may have a communication module capable of performing wireless communication and communicate with the constituent element.

The system 1 for manufacturing edible food products according to the embodiment of the present disclosure may further include a storage medium, and control instructions, which are to be executed by the processor 80, may be stored in the storage medium and used. The storage medium may be a device such as a hard disk drive (HDD), a solid state drive (SSD), a server, a volatile medium, or a non-volatile medium, but the type of storage medium is not limited thereto. In addition, the storage medium may further store data or the like required for the processor 80 to perform the work.

The system 1 for manufacturing edible food products according to the embodiment of the present disclosure may further include an operation part 81. The operation part 81 may include a mechanical structure such as a switch or a button capable of being operated by the user, and a display device configured to display a state of the system 1 for manufacturing edible food products. The operation part 81 may be electrically connected to the processor 80. As illustrated, the operation part 81 may be disposed on an outer surface of a casing embedded with the processor 80, but the arrangement of the operation part 81 is not limited thereto.

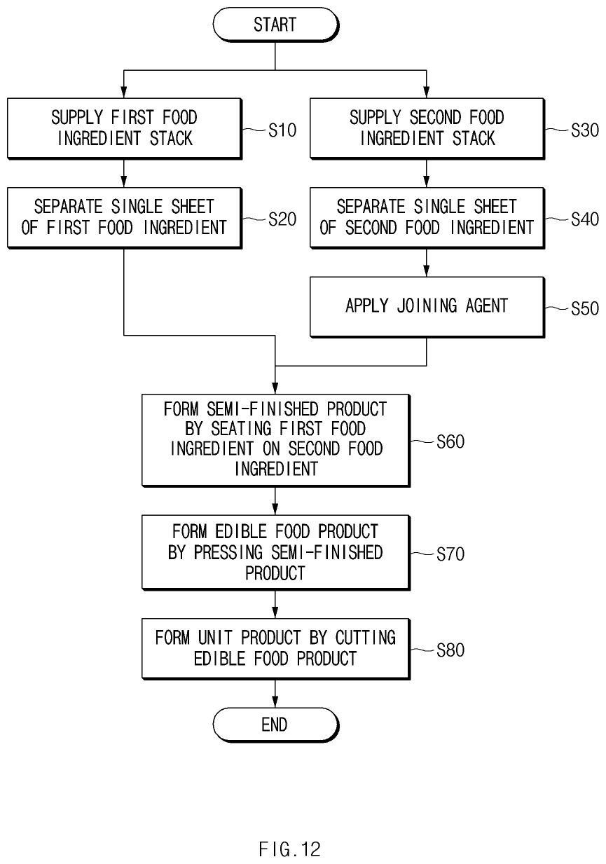

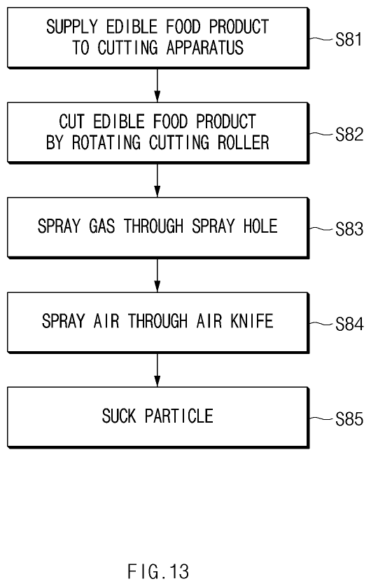

FIG. 12 is a flowchart of a method of manufacturing edible food products according to the embodiment of the present disclosure. FIG. 13 is a flowchart of an edible food product cutting method according to the embodiment of the present disclosure.

Hereinafter, a process in which the processor 80 manufactures the seaweed snack SN by controlling the respective constituent elements of the system 1 for manufacturing edible food products will be described. The flowchart in FIG. 13 may correspond to step S80 in FIG. 12.

The processor 80 may control the first food ingredient cassette movement part 25 and the second food ingredient cassette movement part 35 to allow the seaweed cassette WC, which is embedded with the seaweed stack WS, and the paper cassette PC, which is embedded with the paper stack PS, to move forward. That is, the seaweed stack WS and the paper stack PS may be supplied to the position at which the seaweed stack WS and the paper stack PS may be treated (S10 and S30), and the single sheet of seaweed and the rice paper may be separated (S20 and S40).

The processor 80 may control the first food ingredient transfer part 23 and the second food ingredient transfer part 33 so that the single sheet of seaweed SW and the single sheet of paper move forward. In this case, the processor 80 may control the first food ingredient transfer part 23, the second food ingredient transfer part 33, and the second food ingredient holding roller 34 so that the single sheet of seaweed SW is positioned between the seaweed position fixing bars and the single sheet of rice paper RP is positioned between the second food ingredient position fixing bars 333. In addition, the processor 80 may control the joining agent spray device 41 to spray the joining agent onto the upper surface of the rice paper (S50).

The processor 80 may control the first food ingredient transfer part 23 and the second food ingredient transfer part 33 so that the separated single sheet of seaweed SW is seated on the separated single sheet of rice paper RP to form the semi-finished product HG (S60). The processor 80 may control the first food ingredient transfer part 23 and the second food ingredient transfer part 33 so that the single sheet of seaweed SW and the single sheet of rice paper RP move forward at the same speed and the single sheet of seaweed SW is seated on the single sheet of rice paper RP.

The processor 80 may control the pressing device 50 so that the semi-finished product HG, which has been moved forward and delivered to the pressing device 50, is pressed to form the seaweed snack SN (S70). Thereafter, the processor 80 may control the intermediate conveyor 61 to move forward the seaweed snack SN unloaded from the pressing device 50 (S81). The unit snack SU may be produced by cutting the seaweed snack SN (S80). The processor 80 may control the cutting apparatus 70 so that the seaweed snack SN, which has been delivered to the cutting apparatus 70 by the intermediate conveyor 61, is cut to form the unit snack SU.

After the situation in which the seaweed snack SN reaches the position at which the seaweed snack SN may be cut is identified, the processor 80 may control the cutting apparatus 70 so that the cutting roller 72 rotates and cut the seaweed snack SN (S82), and the processor 80 may control the blowers to spray gas so that particles present at the periphery of the cutting blade 722 are removed. Specifically, the processor 80 may allow gas to be sprayed through the spray hole 723 at the periphery of the cutting blade 722 (S83), and the processor 80 may use the air knife 76 to spray air toward the cutting blade 722 (S84). After the spray process is performed, the processor 80 may control the first cutting suction part and the second cutting suction part to suck particles (S85). The processor 80 may control the unloading conveyor 62 so that the unit snack SU unloaded from the cutting apparatus 70 is moved to the subsequent process.

All the constituent elements, which constitute the embodiment of the present disclosure, may be integrally coupled or operate by being combined, but the present disclosure is not necessarily limited to the embodiment. That is, one or more of the constituent elements may be selectively combined and operated within the object of the present disclosure. In addition, unless explicitly described to the contrary, the words “comprise,” “include,” or “have” and variations such as “comprises,” “comprising,” “includes,” “including,” has,” or “having,” should be understood to imply the inclusion of stated elements but not the exclusion of any other elements. Unless otherwise defined, all terms including technical or scientific terms may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present disclosure.

The above description is simply given for illustratively describing the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

1. A cutting apparatus comprising:
a cutting roller comprising a cutting body having a cylindrical shape and configured to rotate about an axis defined in a leftward/rightward direction, and cutting blades protruding outward in a radial direction of the cutting body further than a surface of the cutting body to cut an edible food product provided in a forward/rearward direction; and
a cutting base part disposed at a position facing the cutting roller based on the edible food product to support the edible food product to be cut by the cutting roller.

2. The cutting apparatus of claim 1, wherein the cutting blades comprise:
a forward/rearward cutting blade extending in a circumferential direction of the cutting body; and
a leftward/rightward cutting blade extending in the leftward/rightward direction, and
wherein a line made by extending the forward/rearward cutting blade and a line made by extending the leftward/rightward cutting blade intersect each other so that the edible food product is cut by the cutting blade and divided into a plurality of unit products.

3. The cutting apparatus of claim 2, wherein the cutting roller further comprises a spray hole which is a hole formed outward in the radial direction from a center of the cutting body to spray gas outward in the radial direction of the cutting body at the periphery of the cutting blade.

4. The cutting apparatus of claim 3, wherein the cutting roller further comprises a blade coupling bolt configured to couple the cutting blade to the cutting body in a direction orthogonal to a direction in which the cutting blade extends, and
wherein the spray hole is disposed inward of the blade coupling bolt based on the radial direction of the cutting body.

5. The cutting apparatus of claim 3, wherein the cutting blades further comprise a connection cutting blade disposed at a position at which the forward/rearward cutting blade and the leftward/rightward cutting blade meet together, the connection cutting blade having a curved surface that connects the forward/rearward cutting blade and the leftward/rightward cutting blade.

6. The cutting apparatus of claim 5, wherein the spray hole is disposed at the periphery of the connection cutting blade.

7. The cutting apparatus of claim 5, wherein the cutting roller further comprises a connection spray hole which is a hole formed in the connection cutting blade outward in the radial direction of the cutting body to spray gas outward in the radial direction of the cutting body.

8. The cutting apparatus of claim 1, further comprising:
a cutting frame comprising a first cutting cover configured to cover the cutting roller so that the cutting roller is positioned in a space formed between the first cutting cover and the cutting base part, the cutting frame being configured such that the cutting base part is coupled to the cutting frame, and the cutting roller is rotatably coupled to cutting frame; and
a first cutting suction part connected to a first cover inlet port formed in the first cutting cover to suck particles at the periphery of the cutting roller.

9. The cutting apparatus of claim 1, further comprising:
a cutting frame to which the cutting base part is coupled, and the cutting roller is rotatably coupled; and
an auxiliary roller disposed at a position facing the cutting roller based on the edible food product to transfer the edible food product forward and support the edible food product to be cut by the cutting roller, the auxiliary roller comprising an auxiliary body coupled to the cutting frame so as to be rotatable about an axis defined in the leftward/rightward direction.

10. The cutting apparatus of claim 9, wherein the cutting frame comprises a second cutting cover configured to cover the auxiliary roller so that the auxiliary roller is positioned in a space formed between the second cutting cover and the cutting base part, and
wherein the cutting apparatus further comprises a second cutting suction part connected to a second cover inlet port formed in the second cutting cover to suck particles at the periphery of the auxiliary roller.

11. The cutting apparatus of claim 9, wherein an auxiliary opening is formed in the cutting base part and extends in the leftward/rightward direction,
wherein the auxiliary opening is opened in an upward/downward direction, and
wherein the auxiliary roller and the cutting roller are disposed at sides opposite to each other based on the auxiliary opening.

12. The cutting apparatus of claim 11, wherein the auxiliary roller further comprises an auxiliary groove recessed inward from the auxiliary body in a radial direction of the auxiliary body so that the cutting blade, which protrudes outward in the radial direction of the cutting body further than a surface of the cutting body, is inserted into the auxiliary groove.

13. The cutting apparatus of claim 1, further comprising:
an air knife disposed to face the cutting blade to spray air to the cutting blade.

14. The cutting apparatus of claim 1, further comprising:
a cutting guide rail extending in the forward/rearward direction and disposed below a surface of the cutting body to prevent the edible food product from being wound around the cutting roller.

15. The cutting apparatus of claim 1, wherein the cutting roller is disposed above the cutting base part.

16. A cutting method comprising:
receiving an edible food product;
cutting the edible food product by rotating a cutting roller comprising a cutting body having a cylindrical shape and configured to rotate about an axis defined in a leftward/rightward direction, and cutting blades protruding outward in a radial direction of the cutting body further than a surface of the cutting body to cut the edible food product provided in a forward/rearward direction; and
spraying gas through a spray hole provided in the cutting body and disposed adjacent to the cutting blade to remove particles at the periphery of the cutting blade.

17. The cutting method of claim 16, further comprising:
sucking the particles from the periphery of the cutting roller to remove the particles after gas is sprayed from the spray hole.

18. The cutting method of claim 16, further comprising:
spraying air to the cutting blade through an air knife to remove the particles after gas is sprayed from the spray hole.
